(19) United States
(12) Patent Application Publication
(10) Pub. No.: US 2024/0090639 A1
(43) Pub. Date: Mar. 21, 2024

(54) ITEM OF LUGGAGE

(71) Applicant: RIMOWA GmbH, Cologne (DE)

(72) Inventor: Walter GIULIO, Cologne (DE)

(73) Assignee: RIMOWA GmbH, Cologne (DE)

(21) Appl. No.: 18/263,197

(22) PCT Filed: Jan. 28, 2022
(86) PCT No.: PCT/EP2022/052112

§ 371 Date: Jul. 27, 2023

(30) Foreign Application Priority Data
Jan. 29, 2021 (EP) 21154375.6

(51) Int. Cl. A45C 13/42; A45C 5/14; C09B 7/10; C09B 57/08

(52) U.S. Cl. CPC A45C 13/42; A45C 5/14; C09B 7/10; C09B 57/08

(57) ABSTRACT

In an item of luggage includes at least six side walls. The side walls each have at least one outer surface and one inner surface, the outer and the inner surface are substantially parallel to each other. At at least one of the side walls, at least one elevation is provided on the associated outer surface, which elevation includes at least one exit surface that at least partially is not parallel to the outer surface of the respective side wall, and at least the side wall which includes the at least one elevation is made from a plastic material that contains a fluorescent dye and is light-conducting and light-transmissive such that light is adapted to be introduced into the respective side wall and transmitted and exit at the respective at least one exit surface. A conversion of invisible UV light into visible light takes place in the respective side wall.

The invention relates to an item of luggage according to claim 1.

Items of luggage, in particular suitcases, are known which comprise at least six side walls, wherein the side walls each comprise at least one outer surface and one inner surface, wherein the outer and the inner surface essentially extend in parallel to each other.

Known items are frequently problematic in that the items of luggage are difficult to identify on the luggage carousel in the case of flights. Therefore, there is an increasing demand for marking or individualizing the items of luggage. This is frequently realized with luggage straps of different colors which are placed around the suitcase.

It is therefore an object of the present invention to provide an item of luggage which is well identifiable from afar.

This object is achieved with the features of claim 1.

According to the invention, it is advantageously provided that at least one elevation is arranged at at least one of the side walls on the associated outer surface, which elevation comprises at least one exit boundary surface which does not extend in parallel to the outer surface of the respective side wall, and that at least the side wall comprising the at least one elevation is made from a plastic material which contains a fluorescent material and is light-conducting and light-transmissive such that light is adapted to be introduced into the side wall and transmitted and exit at the respective at least one exit boundary surface, wherein a conversion of invisible UV light into visible light takes place in the side wall.

The present invention offers the advantage that the item of luggage, in particular the suitcase, is illuminated at the at least one elevation. A portion of the light incident from the environment is absorbed by the fluorescent material and emitted as a longwave fluorescent radiation in all spatial directions. The portion of the light that impinges onto the outer surface of the respective side wall, which constitutes the boundary surface between the side wall and the ambient air, at an angle which exceeds the critical angle of the total internal reflection, is subjected to a total internal reflection and hence stays in the corresponding side wall. That is to say that the light is collected.

Since the at least one elevation on the corresponding outer surface comprises an exit boundary surface which is not parallel to the outer surface of the respective side wall, the light, at this location, impinges onto the exit boundary surface at another angle than onto the outer surface. Hence, the light impinges onto the exit boundary surface at an angle which is smaller than the critical angle of the total internal reflection. This causes the light at the respective elevation to exit the side wall. The light collected so far exits the outer wall at the elevations. Hence, the respective elevation is always brighter than its environment. In this manner, an item of luggage is created which is identifiable from afar. In particular, the item of luggage on a luggage carousel can well be identified from afar.

The fluorescent material can also be referred to as fluorescent dye.

The exit boundary surface of the elevation can have a surface roughness which is higher than the surface roughness of the outer surface where the elevation is arranged. Hence, the coupling-out of the light at the elevation can be improved.

The exit boundary surface can have an angle ranging between 80 and 170° with respect to the outer surface.

The at least one elevation can be a rib-shaped elevation.

The rib-shaped elevation can have a round, a triangular or a rectangular cross-section.

A plurality of elevations forming a pattern can be arranged side by side on the outer surface of the at least one side wall.

At least two, preferably all side walls can comprise at least one elevation at least on the associated outer surface, which elevation respectively comprises at least one exit boundary surface that is not parallel to the outer surface of the respective side wall, and at least the side wall respectively comprising the at least one elevation is made from a plastic material which contains a fluorescent material and is light-conducting and light-transmissive such that light is adapted to be introduced into the side walls and transmitted and exit at the respective exit boundary surface, wherein a conversion of invisible UV light into visible light takes place in the side wall.

The fluorescent material can be a fluorescent dye. The fluorescent material can be contained in the plastic material to an amount of 0.3-5%, preferably 0.5-1.5%.

The fluorescent material can be from the group of naphthalimides and thioindigo.

The side walls can each have a thickness ranging between 0.4-10 mm, preferably 0.8-1.8 mm Here, the thickness is defined by the distance between the inner surface and the outer surface.

Any polymer, in particular transparent polymer and/or a mixture of various polymers and/or recycled polymer, can be used as the plastic material. Particularly preferably, polycarbonate, preferably transparent polycarbonate, can be used.

Hereunder exemplary embodiments of the present invention will be explained in detail with reference to the drawings in which:

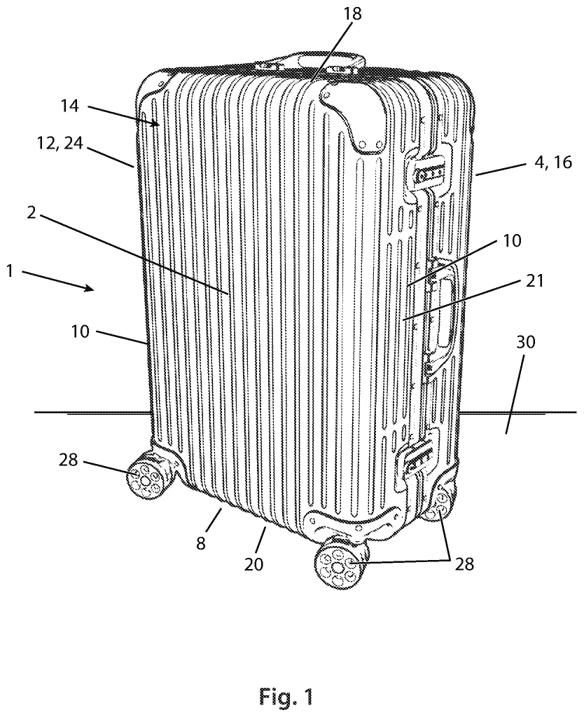

FIG. 1 schematically shows an item of luggage,

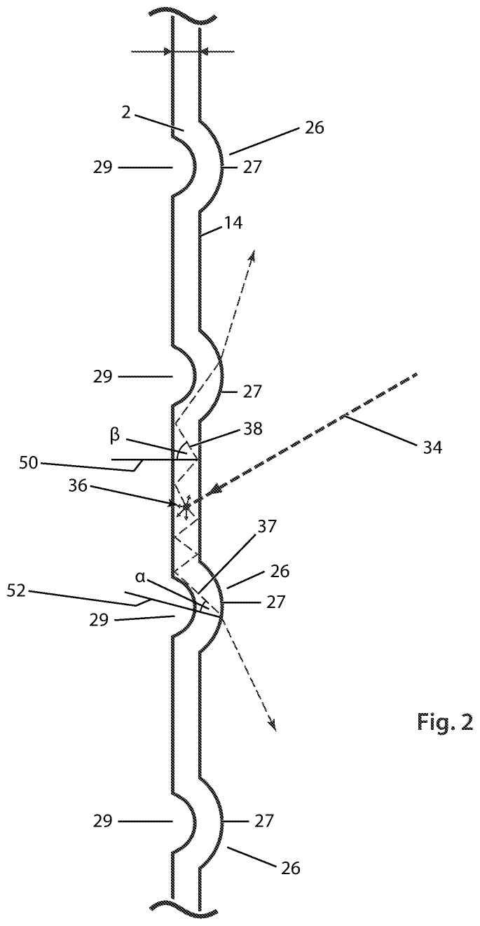

FIG. 2 schematically shows a cross-section of a side wall of the item of luggage,

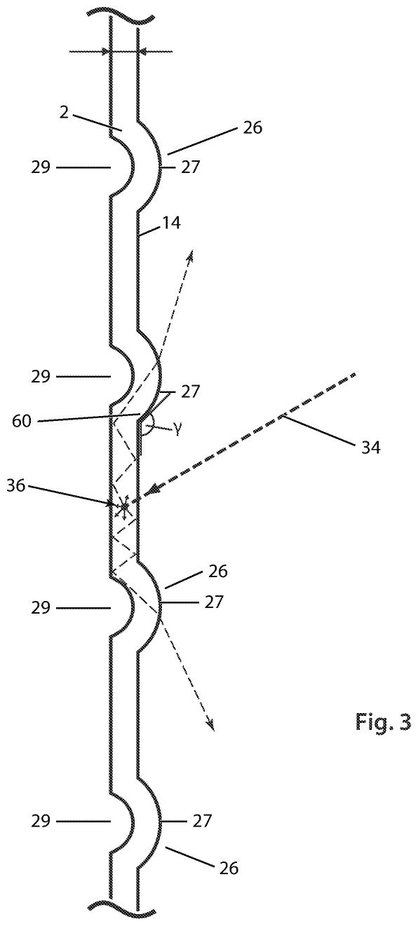

FIG. 3 schematically shows a cross-section of a side wall with an illustrated angle between exit boundary surface and outer surface,

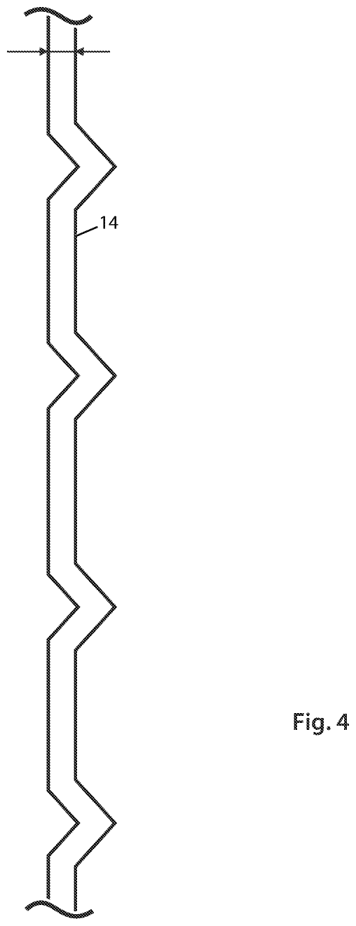

FIG. 4 schematically shows a cross-section of a side wall of the item of luggage having alternative elevations.

FIG. 1 shows an item of luggage 1 according to the present invention. As illustrated, the item of luggage can be a suitcase. The item of luggage 1 comprises six side walls 2, 4, 6, 8, 10, 12. The side walls 2, 4, 6, 8, 10, 12 can each comprise an outer surface 14, 16, 18, 20, 22, 24 and an inner surface not illustrated, wherein the outer and the inner surface each extend essentially in parallel to each other.

A side surface 8 is arranged on the lower side of the item of luggage. Luggage casters 28 can be arranged on the side surfaces 8 constituting the lower side, wherein, in the present case, the item of luggage 1 comprises four luggage casters 28. However, fewer or more luggage casters can be provided. The item of luggage 1 can be moved on a ground surface 30 with the aid of the luggage casters 28.

At least one of the side surfaces 2, 4, 6, 8, 10, 12 comprises at least one elevation 26 on the respective outer surface. In the illustrated exemplary embodiment, each side surface comprises at least one elevation 26. As shown in the illustrated exemplary embodiment, a plurality of elevations 26 arranged side by side can be provided on the respective outer surface. The plurality of elevations arranged at regular intervals to each other thus form a pattern.

FIG. 2 illustrates a portion of a cross-section of the side wall 2. Generally, the side surfaces which comprise at least one elevation have a similar configuration. The side wall 2 comprises an outer surface 14 and an inner surface 25. The side wall 2 comprises at least one elevation 26. In the illustrated exemplary embodiment, a plurality of elevations 26 are provided. The elevations 26 are elevated relative to the outer surface 14 in a direction towards the outside. The at least one elevation 26 respectively comprises at least one exit boundary surface 27.

The exit boundary surface 27 is arranged such that it is at least partially not parallel to the outer surface 14. The cross-section of the elevation 26 has a round shape. Therefore, the exit boundary surface 27 does not have a defined angle with respect to the outer surface 14 but has different angles with respect to the outer surface 14 at different locations. The elevation can also have a triangular or a rectangular or any other cross-section.

According to the illustrated exemplary embodiment, on the inner surface a recess recessed relative to the inner surface is arranged in the area of the elevation. Alternatively, the inner surface can be continuous and not have any recesses. The thickness d of the side wall corresponding to the distance between outer surface and inner surface amounts to 0.3-10 mm, preferably 0.8-1.8 mm.

The side wall 2 or the side walls comprising the at least one elevation 26 are made from a plastic material containing a fluorescent material and are light-conducting and light-transmissive such that light is adapted to be introduced into the side wall and transmitted and exit at the respective at least one exit boundary surface, wherein a conversion of invisible UV light into visible light takes place in the side wall.

This will be explained in detail with reference to FIG. 2. The item of luggage according to the invention, in particular the suitcase, offers the advantage that the at least one elevation is illuminated. FIG. 2 illustrates how a portion of the light 34 incident from the environment is absorbed by the fluorescent material and emitted as a longwave fluorescent radiation 36 in all spatial directions. As is shown in FIG. 2, the portion 38 of the fluorescent radiation that impinges onto the outer surface 14 of the respective side wall at an angle β exceeding the critical angle of the total internal reflection is subjected to a total internal reflection and hence stays in the corresponding side wall 2. That is to say that the light is collected. The outer surface 14 constitutes the boundary surface between the side wall 2 and the ambient air. The angle β is the angle between the portion 38 of the fluorescent radiation and the perpendicular 50 at this location.

Since the at least one elevation 26 comprises an exit boundary surface 27 which is at least partially not parallel to the outer surface 14 of the respective side wall 2, at this location the portion 37 of the fluorescent radiation impinges onto the exit boundary surface 27 at another angle α than onto the outer surface 14. Hence, the light impinges onto the exit boundary surface 27 at an angle α which is smaller than the critical angle of the total internal reflection. This causes the light radiation at the respective elevation 26 to exit the side wall 2. The light collected so far exits the side wall 2 at the elevations 26. Hence, the respective elevation 26 is always brighter than its environment. In this manner, an item of luggage is created which can be identified from afar. In particular, the item of luggage can well be identified on a luggage carousel. The angle α is the angle between the portion 37 of the fluorescent radiation and the perpendicular 52 at this location.

The exit boundary surface 27 of the elevation 26 can have a surface roughness which is higher than the surface roughness of the outer surface 14 where the elevation 26 is arranged. Hence, the coupling-out of the light at the elevation can be improved.

At least portions of the exit boundary surface 27 can have an angle γ ranging between 80 and 170° with respect to the outer surface. For example, FIG. 3 illustrates the angle γ comprising the marked area 50 of the exit boundary surface 27 with respect to the outer surface 14.

The illustrated elevations are rib-shaped elevations. However, they can also have another shape. The elevation, in particular the rib-shaped elevation, can have a round, a triangular or a rectangular cross-section.

FIG. 4 illustrates alternative cross-sectional shapes of the elevations.

1-11. (canceled)

12. An item of luggage, in particular a suitcase, comprising:
at least six side walls, wherein each side wall has at least one outer surface and one inner surface, wherein the outer and the inner surface are substantially parallel to each other,
wherein at least at one of the side walls at least one elevation is provided on the associated outer surface, which elevation comprises at least one exit surface that is at least partially not parallel to the outer surface of the respective side wall, and at least the side wall which comprises the at least one elevation is made from a plastic material that contains a fluorescent dye and is light-conducting and light-transmissive such that light is adapted to be introduced into the respective side wall and transmitted and exit at the respective at least one exit surface, wherein a conversion of invisible UV light into visible light takes place in the respective side wall.

13. The item of luggage according to claim 12, wherein the exit surface of the elevation has a surface roughness that is higher than the surface roughness of the outer surface on which the elevation is arranged.

14. The item of luggage according to claim 12, wherein at least a portion of the exit boundary surface has an angle ranging between 80 and 170° with respect to the outer surface.

15. The item of luggage according claim 12, wherein the at least one elevation is a rib-shaped elevation.

16. The item of luggage according to claim 15, wherein the elevation, in particular the rib-shaped elevation, has a round, a triangular or a rectangular cross-section.

17. The item of luggage according to claim 12, wherein a plurality of elevations forming a pattern are arranged side by side on the outer surface of the at least one side wall.

18. The item of luggage according to claim 12, wherein at least two, preferably all side walls comprise at least one elevation at least on the associated outer surface, which elevation respectively comprises at least one exit boundary surface that at least partially is not parallel to the outer surface of the respective side wall, and that at least the side wall which respectively comprises the at least one elevation is made from a plastic material which contains a fluorescent material and is light-conducting and light-transmissive such that light is adapted to be introduced into the side walls and transmitted and exit at the respective exit boundary surface, wherein a conversion of invisible UV light into visible light takes place during the transmission.

19. The item of luggage according to claim 12, wherein the fluorescent dye is contained in the plastic material to an amount of 0.3-5%, preferably 0.5-1.5%.

20. The item of luggage according to claim 12, wherein the fluorescent material can be from the group of naphthalimides and thioindigo.

21. The item of luggage according to claim 12, wherein the side walls each have a thickness ranging between 0.4-10 mm, preferably 0.8-1.8 mm.

22. The item of luggage according to claim 12, wherein the plastic material comprises polycarbonate, preferably transparent polycarbonate.
